(19) United States
(12) Patent Application Publication
(10) Pub. No.: US 2009/0060244 A1
(43) Pub. Date: Mar. 5, 2009

(54) Face-to-face communication apparatus

(75) Inventors: Yoshiaki Haramura, Osaka (JP); Takamichi Tanimoto, Osaka (JP); Kuniyuki Banno, Aichi (JP); Futoshi Tanaka, Aichi (JP)

Correspondence Address: K&L Gates LLP, 214 N. TRYON STREET, HEARST TOWER, 47TH FLOOR, CHARLOTTE, NC, 28202, US

(73) Assignee: NIHON DENON KABUSHIKI KAISHA, Osaka (JP)

(21) Appl. No.: 11/666,712

(22) PCT Filed: Nov. 1, 2004
(86) PCT No.: PCT/JP04/16241

§ 371 Date: Apr. 30, 2007

(51) Int. Cl. H04R 1/02

(52) U.S. Cl. 381/332

(57) ABSTRACT

An object is to provide a face-to-face communication apparatus in which, the safety in the inside of the chamber is ensured with a simple structure without drilling holes in the partitioning wall; there is no obstacle against viewing between the inside and the outside of the chamber; and communication or work can be carried out well between the persons in the inside and on the outside of the chamber without giving a sense of incompatibility to the person on the outside of the chamber due to the source of the voice of the person in the inside. Disclosed herein is a face-to-face communication apparatus that performs communication face to face via a transparent or semi-transparent wall that partitions between the inside and the outside of a chamber, said face-to-face communication apparatus being provided with a speaker that outputs voices from the inside of the chamber and a microphone that collects voices from the outside of the chamber, characterized in that said speaker outputs to the outside of the chamber via an acoustic pipe from an opening thereof. Preferably, microphones having different polarities are respectively incorporated onto both sides of the speaker output opening of said acoustic pipe.

### TECHNICAL FIELD OF THE INVENTION

The present invention relates to a face-to-face communication apparatus for allowing communication to proceed face to face smoothly via a wall that partitions between the inside and the outside of a chamber such as seen in a ticket-selling counter of a railroad or the like, a ticket-selling counter of a movie theater, a drama theater, or the like, or in a face-to-face talking system.

### BACKGROUND ART

A typical conventional face-to-face communication apparatus will be described with use of the conventional example of FIG. 1.

Hereafter, description will be made by raising particularly an example of a ticket-selling counter among the face-to-face communication apparatus.

Typically, the ticket-selling counter is adapted so that a seller 103 that sells tickets within a chamber may talk with a purchaser 104 that comes to purchase a ticket and allow actions such as “requesting for a needed ticket”, “receiving money by providing the ticket”, and the like to be performed smoothly, whereby tickets without errors may be sold.

Typically, at the ticket-selling counter, a transparent partitioning plate 108 is placed between the seller 103 and the purchaser 104, whereby it is so constructed that the two can talk with each other while confirming the face of the counterpart. Sound holes are placed in the transparent partitioning plate. However, the opening degree of the sound holes can be ensured only up to about 10 to 15% because of safety reasons and the like. Therefore, in the talk between the seller 103 and the purchaser 104, there are a case in which the sound volume of the uttered voice is low, a case in which the contents of the uttered voice is erased by the surrounding noise and cannot be heard well, and a case in which one cannot make a sufficient talk with an elderly person who is less capable of hearing, so that there has been a need for electrically magnify the sound of mutual talk.

In the case of electrically magnifying the mutual talk, the voice of the seller 103 is picked up by the transmitting microphone 106, amplified by the face-to-face voice-magnifying apparatus 105, and is transmitted to the purchaser 104 by the outside-chamber speaker 110; and the voice of the purchaser 104 is picked up by the receiving microphone 107, amplified by the face-to-face voice-magnifying apparatus 105, and is output and transmitted to the seller 103 by the inside-chamber speaker 109, thereby to achieve communication.

However, the above-described face-to-face communication apparatus has a defect such that, since the purchaser 104 talks while looking at the face of the seller 103 and does not pay attention to the position of the microphone, the voice is not input at an appropriate level into the microphone. Also, in the case in which the speaker for magnifying the voice of the seller 103 is an outside-chamber speaker 110 placed at a position different from that anticipated by the purchaser, since the voice comes out from the position different from that anticipated by the purchaser 104, defects were generated such that a first-time visitor in particular will be at a loss and cannot smoothly carry out the conversation for purchasing a ticket.

In order to eliminate such defects, the present inventors have proposed a face-to-face communication apparatus such that, in the wall that partitions between the inside and the outside of a chamber, a space is provided with a transparent plate having sound holes attached thereto and a transparent plate that shuts out the sound, and a speaker is directly placed in the space or a speaker is placed via an acoustic duct (See Japanese Patent Application Laid-Open (JP-A) No. 2001-24803). This apparatus is excellent in that communication or work between the inside and the outside of the chamber is carried out smoothly; however, since a space is provided in the partitioning wall, the structure of the partitioning wall is complex and moreover is weak in the strength, thereby raising a problem in view of safety.

### DISCLOSURE OF THE INVENTION

### Problems that the Invention is to Solve

The present invention has been devised in view of such present circumstances of the prior art, and an object thereof is to provide a face-to-face communication apparatus in which, as a face-to-face communication apparatus that performs communication face to face via a wall that partitions between the inside and the outside of a chamber, the safety in the inside of the chamber is ensured with a simple structure without drilling holes in the partitioning wall; there is no obstacle against viewing between the inside and the outside of the chamber; and communication or work can be carried out well between the persons in the inside and on the outside of the chamber without giving a sense of incompatibility to the person on the outside of the chamber due to the source of the voice of the person in the inside.

### Means for Solving the Problems

In order to achieve the object described above, the present inventors have made eager studies and, as a result, have found out that the aforementioned object can be achieved by transmitting the voice output that is issued from the speaker that outputs the voice of the inside of the chamber to the outside of the chamber via an acoustic pipe, thereby completing the present invention.

Namely, the present invention is a face-to-face communication apparatus that performs communication face to face via a transparent or semi-transparent wall that partitions between the inside and the outside of a chamber, said face-to-face communication apparatus being provided with a speaker that outputs voices from the inside of the chamber and a microphone that collects voices from the outside of the chamber, characterized in that said speaker outputs to the outside of the chamber via an acoustic pipe from an opening thereof.

According to a preferable embodiment of the present invention, said acoustic pipe is placed on said wall, on a counter that is continuous to said wall, or on a ceiling located on the outside of the chamber, and the cross-sectional shape of said acoustic pipe is a circular shape, a semi-circular shape, an elliptic shape, a polyhedral shape, an analogous shape thereof, or a combination thereof. Also, according to a preferable embodiment of the present invention, said microphone is incorporated in said acoustic pipe, or is placed separately from said acoustic pipe. Also, according to a preferable embodiment of the present invention, microphones having different polarities are respectively incorporated onto both sides of the speaker output opening of said acoustic pipe. Also, according to a preferable embodiment of the present invention, the cross-sectional area of said acoustic pipe is 50 mm² to 400 mm². Also, according to a preferable embodiment of the present invention, the signal of said microphone is transmitted as an electric signal within said acoustic pipe.

At a ticket-selling counter or the like located in a place where the inside and the outside of a chamber are partitioned, good communication between a seller and a purchaser is important. Also, the safety of the seller in the inside of the chamber must be ensured. For that purpose, the present invention proposes a face-to-face communication apparatus such as described above in which the conversation between the seller and the purchaser can make a state such that the two are performing natural conversation while facing each other via an amplifying apparatus even if there is a transparent partitioning plate between the inside and the outside of the chamber and, moreover, the safety of the persons in the inside of the chamber is ensured with a simple structure.

### BRIEF DESCRIPTION OF THE DRAWINGS

FIG. 1 shows a descriptive view of a conventional example at a ticket-selling counter.

FIG. 2 shows a descriptive view of the present invention at a ticket-selling counter.

FIG. 3 shows a descriptive view of an acoustic pipe part, where (a) is an example of the case in which an opening for a receiving microphone is located at one site, and (b) is an example of the case in which openings for a receiving microphone are placed on both sides of a voice outlet.

FIG. 4 shows an example of placing a vertical-type acoustic pipe part.

FIG. 5 shows an example of placing a horizontal-type acoustic pipe part.

FIG. 6 shows an example of placing an arch-type acoustic pipe part.

FIG. 7 shows an example of placing a signboard-type acoustic pipe part.

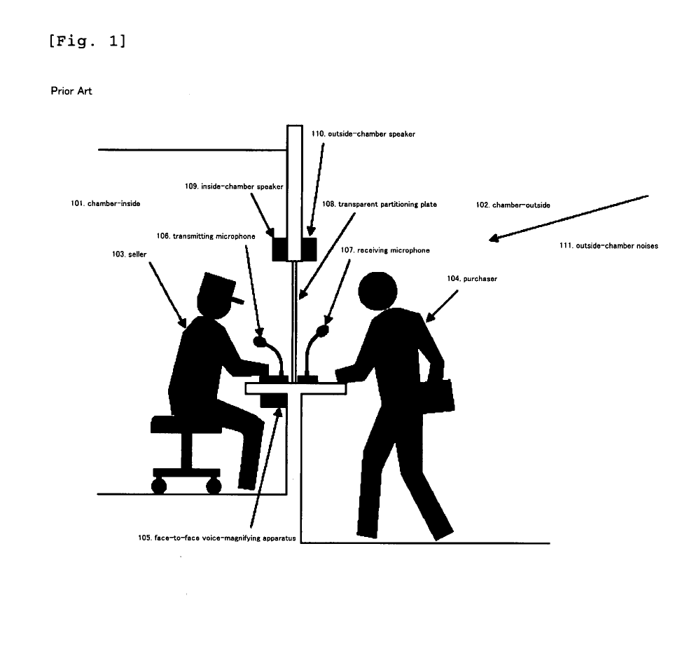

### BEST MODE FOR CARRYING OUT THE INVENTION

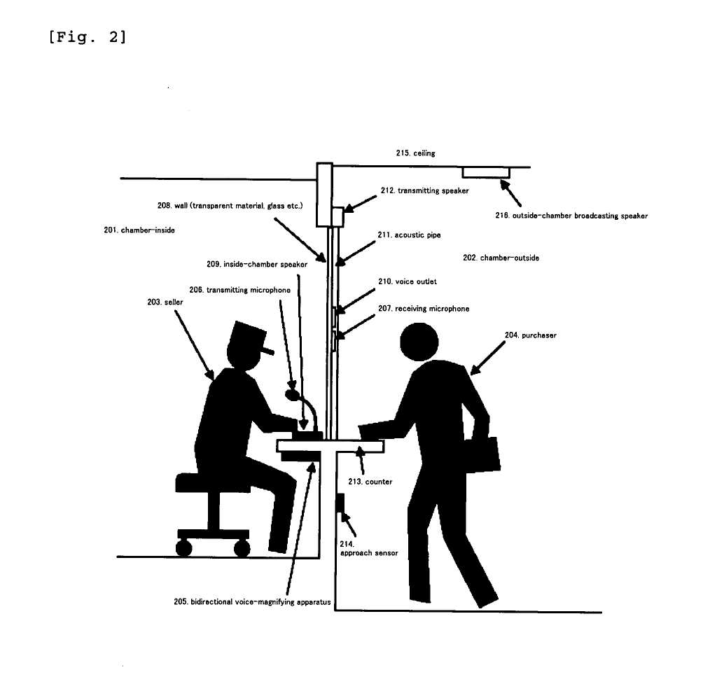

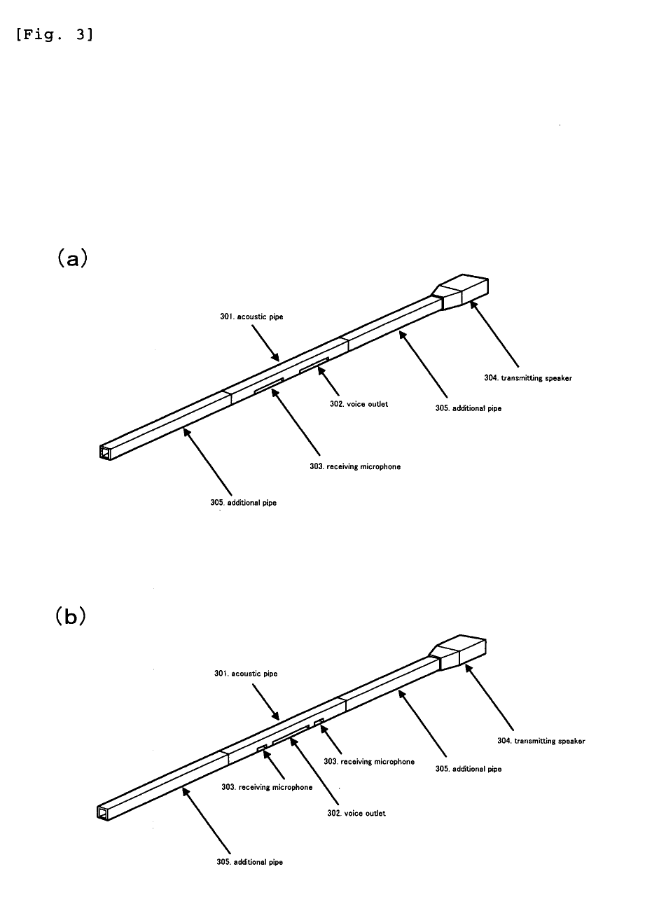

An example of the face-to-face communication apparatus of the present invention will be described with use of the present invention example of FIG. 2 and the descriptive view of the acoustic pipe part of FIG. 3. The face-to-face communication apparatus of the present invention is adapted so that the dialogue between a seller 203 and a purchaser 204 is carried out while the two are viewing and recognizing each other through a wall 208 made of a transparent material such as glass. To the wall 208, an acoustic pipe 211 (301) made of a metal such as aluminum or a resin material such as plastics is attached. In the acoustic pipe 211 (301), a voice outlet 210 (302) which is an opening for outputting voices is provided, whereby the voice of the seller 203 that is output from a transmitting speaker 212 (304) incorporating a driver unit therein passes through the acoustic pipe 211 (301) to be output from the voice outlet 210 (302), thereby to transmit the voice to the purchaser 204 located on the outside of the chamber.

The acoustic pipe 211 (301) to be used in the present invention may be designed to have any design as long as the shape and the inside of the pipe are suitable for transmittance of sound. For example, as the cross-sectional shape of the acoustic pipe 211 (301), a circular shape, a semi-circular shape, an elliptic shape, a polyhedral shape, an analogous shape thereof, or a combination thereof may be mentioned. For adjustment of the length, additional pipes 305 made of the same material but without having a voice outlet 210 (302) can be used, as shown in FIG. 3, and the length of the pipe can be suitably adjusted by joining these. Also, the voice outlet 210 (302) of the acoustic pipe 211 (301) can be disposed at any place; however, it is preferably disposed in the midway other than the end surfaces, for example, approximately at the middle part of the acoustic pipe, as shown in FIG. 3. In particular, when the acoustic pipe is to be placed at the ticket-selling counter, the voice outlet 210 (302) is preferably disposed at a position near to the face of the purchaser so as to facilitate the hearing of the purchaser. Also, the acoustic pipe 211 (301) to be used in the present invention preferably has a cross-sectional area of 50 mm² to 400 mm². Owing to this, the cross-sectional area of the acoustic pipe will not have an extremely conspicuous dimension in the placed state, thereby further improving the degree of freedom for the placement of the acoustic pipe 211 (301).

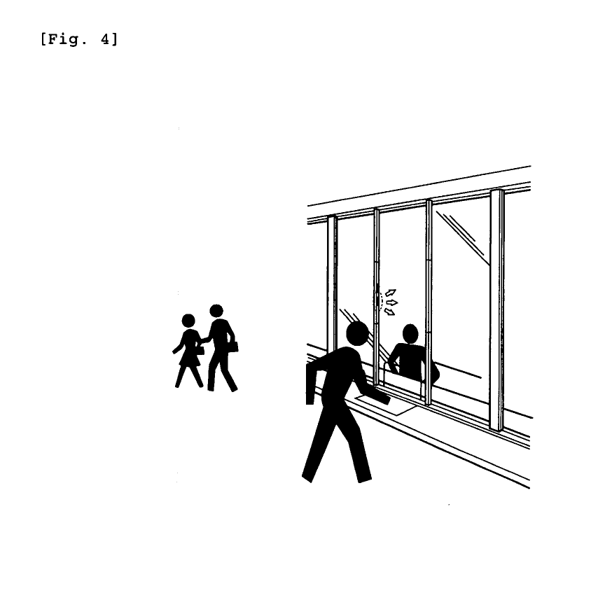

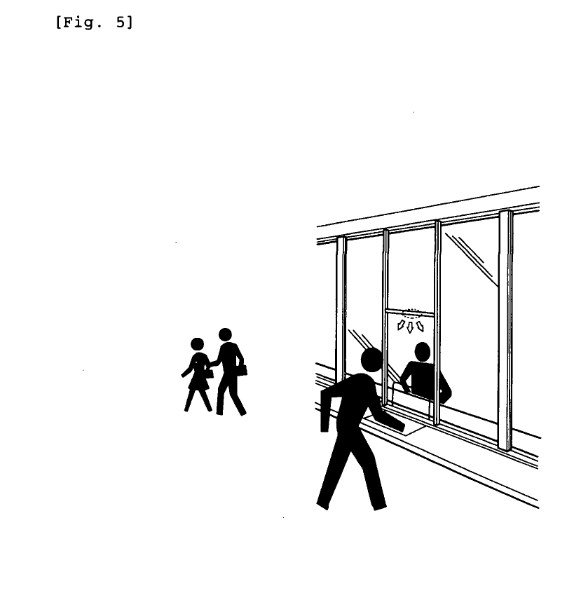

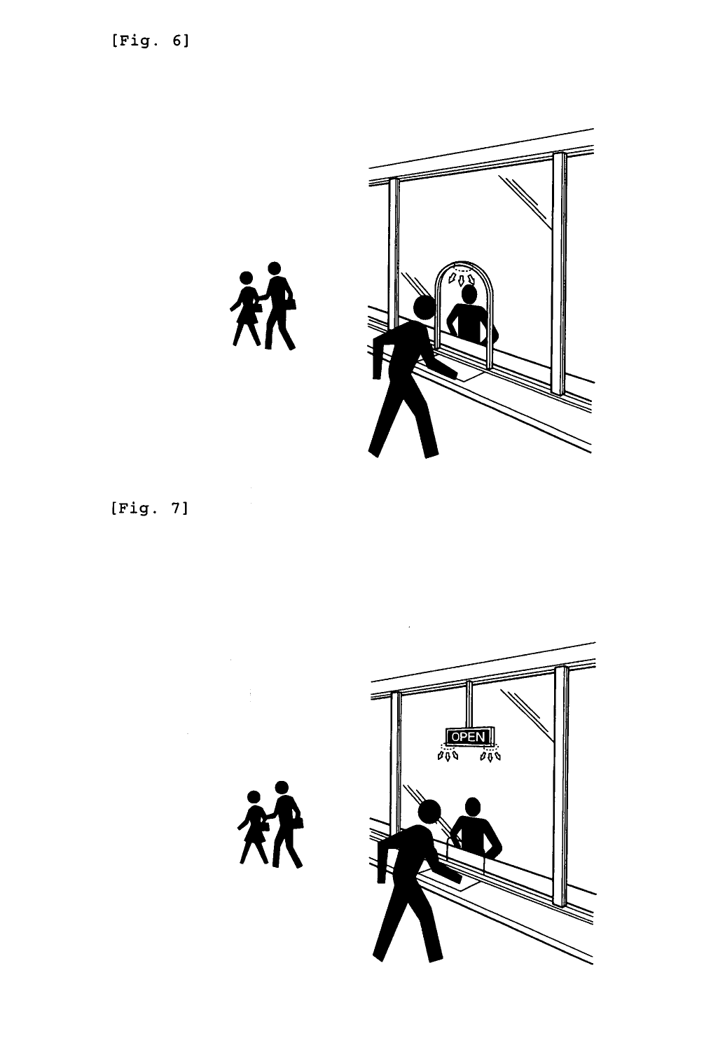

The acoustic pipe 211 (301) to be used in the present invention may be placed on a wall 208 that partitions between the seller 203 and the purchaser 204, on a counter 213 that is continuous to the wall 208, or on a ceiling 215 located on the outside of the chamber. As a method of fixation thereof, various methods such as a two-sided tape, an adhesive agent, fitting-in, or welding may be adopted. In performing the placement, it is preferable to make the presence and the function of the acoustic pipe 211 (301) be unrecognizable by the purchaser 204. For example, in the case of placing the acoustic pipe on the wall 208, one may consider an example of placing a vertical-type acoustic pipe such as in FIG. 4, an example of placing a horizontal-type acoustic pipe such as in FIG. 5, an example of placing an arch-type acoustic pipe such as in FIG. 6, and an example of placing a signboard-type acoustic pipe such as in FIG. 7.

The face-to-face communication apparatus of the present invention is equipped with a receiving microphone 207 (303) that collects the voices on the outside of the chamber in addition to the speaker that outputs the voices of the inside of the chamber. The receiving microphone 207 (303) may be incorporated into the acoustic pipe 211 (301) to be integral with the voice outlet 210 (302) as shown in FIGS. 2 and 3, whereby the collected voices will be converted into an electric signal by the receiving microphone 207 (303) and transmitted as an electric signal via an interconnect line (not illustrated) within the acoustic pipe 211 (301). According to this method, since the collected voices are transmitted as an electric signal, the conversation will be easier as compared with a general voice-transmitting pipe. Also, the receiving microphone 207 (303) may be made to be of separate type as desired. In the case of the separate type, the receiving microphone may be of a wireless type.

When the opening for the receiving microphone 207 (303) is located at one site in the face-to-face communication apparatus of the present invention as shown in FIG. 3(a), there is an example in which one receiving microphone is used; however, when two microphones having different polarities are mounted, the amount of input of surrounding noises can be alleviated by the differential effect. Also, when openings for the receiving microphone (303) are disposed on both sides of the voice outlet 210 (302) of the acoustic pipe 211 (301), and two microphones having different polarities are placed respectively on the two sides as shown in FIG. 3(b), not only the amount of input of the surrounding noises can be alleviated but also the cancellation power can be made to be the greatest even if the voice of the seller 203 (transmitting output) goes around to the receiving input. This placement can be carried out in a similar manner with an ordinary speaker unit; however, since the speaker unit is large, it is difficult to place two microphones having different polarities at an effective interval. According to the placement into the acoustic pipe of the present invention, the outlet of sound is as small as the outer shape of the microphone and, moreover, a free shape can be made, thereby enabling an effective placement.

Next, a general mode of use of the face-to-face communication apparatus of the present invention will be specifically described.

The apparatus of the present invention is constructed by placing a transmitting speaker 212 and an acoustic pipe 211 on a wall 208 made of a transparent material such as glass through which a seller 203 in the chamber-inside 201 faces a purchaser 204 on the chamber-outside 202 as shown in FIG. 2. When the purchaser 204 approaches the ticket-selling counter, one can confirm it through the wall 208 made of a transparent material such as glass and, moreover, one can sense with an approach sensor 214 that the purchaser has come to the ticket-selling counter by the body temperature of human beings, an acoustic sound, a radar system, a pressure switch, or the like. Whether it has been sensed or not can be confirmed also by a displaying apparatus (not illustrated). By this sensing signal, a bidirectional voice-magnifying apparatus 205 will be ready for communication. At this time, when a starting switch that plays a role of the sensor is disposed in the bidirectional voice-magnifying apparatus 205, the seller 203 may press the starting switch to make the state of being ready for communication.

When the seller 203 in the chamber-inside 201 utters, for example, a question for confirming a destination station, a voice is input into the transmitting microphone 206. The voice signal of the seller 203 that has been input into the transmitting microphone 206 is amplified to a suitable level by an amplification apparatus.

The amplified voice signal is input into an amplification apparatus that performs power amplification needed for driving a transmitting speaker 212 or an outside-chamber broadcasting speaker 216, and the further amplified voice output is output into either of them by a switching switch for operating the transmitting speaker 212 or the outside-chamber broadcasting speaker 216. The transmitting speaker 212 is used when the seller 203 directly talks to a purchaser 204 that has come in front of the counter and, on the other hand, the outside-chamber broadcasting speaker 216 is used when a general guidance as a station is given to a plurality of purchasers located on the outside of the chamber, when a purchaser of a ticket has left the counter by erroneous recognition, or the like. The output of the transmitting speaker 212 is output to the purchaser 204 through the intermediary of the acoustic pipe 211 from the voice outlet 210 thereof.

The voice of the purchaser 204 is input into the receiving microphones 207 located within the acoustic pipe 211 that is mounted on the wall 208 made of a transparent material such as glass. Two receiving microphones 207 are incorporated, and the two signals are respectively subjected to phase control by a phase controlling apparatus and are then input into a noise controlling apparatus to be subjected to a control such that the voice of the purchaser 204 may pass easily but the noise of the surroundings may not pass easily. Thereafter, the signals are amplified to an appropriate level by an amplification apparatus. The amplified voice is output to an output amplification apparatus that performs power amplification needed for driving the inside-chamber speaker 209, whereby the voice of the purchaser 204 is output to the seller 203 from the inside-chamber speaker 209.

Because of having a construction such as described above, the face-to-face communication apparatus of the present invention can produce effects such as described below.
(i) Since there is no need to drill a hole in the windowpane of a counter, it is easy to place bullet-proof glass, thereby improving the safety. For example, when the windowpane of a counter is made of bullet-proof glass, drilling a hole in it reduces the strength thereof, and the work thereof is accompanied by difficulties; however, the present invention provides an improvement on it.
(ii) Since the voices in the inside of a chamber are output to the outside of the chamber through an acoustic pipe without using a conventional speaker, so that the field of view between the inside and the outside of the chamber is not hindered and, moreover, no sense of incompatibility is given to the communication between the seller and the purchaser.
(iii) Since an aluminum building material can be used for the acoustic pipe, the acoustic pipe can be placed at a low cost. Also, the presence of the transmitting speaker and the receiving microphone can be hidden, so that the counter section can be constructed in a simple manner.
(iv) Since a receiving microphone can also be incorporated into the acoustic pipe, transmitting and receiving acoustic functions can be obtained with one pipe, thereby providing efficiency.
(v) By using a bent acoustic pipe or the like, it can be fabricated as an acoustic apparatus that is integrated with structures such as a guidance board, a displaying lamp, and a windowpane, thereby attaining fusion with an architectural design.
(vi) Since the cross-sectional shape of the acoustic pipe can be deformed in various ways, and the cross-sectional area of the acoustic pipe can be reduced, it can cope with mischief against the acoustic pipe caused by an unspecified number of outside visitors.

1. A face-to-face communication apparatus that performs communication face to face via a transparent or semi-transparent wall that partitions between the inside and the outside of a chamber, said face-to-face communication apparatus being provided with a speaker that outputs voices from the inside of the chamber and a microphone that collects voices from the outside of the chamber, characterized in that said speaker outputs to the outside of the chamber via an acoustic pipe from an opening thereof.

2. The face-to-face communication apparatus according to claim 1, wherein said acoustic pipe is placed on said wall, on a counter that is continuous to said wall, or on a ceiling located on the outside of the chamber.

3. The face-to-face communication apparatus according to claim 1 or 2, wherein the cross-sectional shape of said acoustic pipe is a circular shape, a semi-circular shape, an elliptic shape, a polyhedral shape, an analogous shape thereof, or a combination thereof.

4. The face-to-face communication apparatus according to any of claims 1 to 3, wherein said microphone is incorporated in said acoustic pipe.

5. The face-to-face communication apparatus according to any of claims 1 to 3, wherein said microphone is placed separately from said acoustic pipe.

6. The face-to-face communication apparatus according to claim 4, wherein microphones having different polarities are respectively incorporated onto both sides of the speaker output opening of said acoustic pipe.

7. The face-to-face communication apparatus according to any of claims 1 to 6, wherein the cross-sectional area of said acoustic pipe is 50 mm² to 400 mm².

8. The face-to-face communication apparatus according to any of claims 4 to 6, wherein the signal of said microphone is transmitted as an electric signal within said acoustic pipe.
